(19) United States
(12) Patent Application Publication
(10) Pub. No.: US 2013/0052493 A1
(43) Pub. Date: Feb. 28, 2013

(54) HEAT DISSIPATION DEVICE

(71) Applicants: Tim Schaefer, Harztor (DE); Claus-Rupert Hohenthanner, Hanau (DE)

(72) Inventors: Tim Schaefer, Harztor (DE); Claus-Rupert Hohenthanner, Hanau (DE)

(73) Assignee: LI-TEC BATTERY GMBH, Kamenz (DE)

(21) Appl. No.: 13/638,025

(22) PCT Filed: Mar. 28, 2011
(86) PCT No.: PCT/EP2011/001549

§ 371 Date: Nov. 14, 2012

(30) Foreign Application Priority Data
Mar. 29, 2010 (DE) 10 2010 013 195.4

(51) Int. Cl. F28F 27/00; H01M 10/42

(52) U.S. Cl. 429/52; 165/11.1

(57) ABSTRACT

A heat dissipation device according to the invention has a first measuring device. This is provided for detecting a physical parameter. The heat dissipation device according to the invention has a heat-conducting device. Said heat-conducting device is provided for absorbing thermal energy from an adjacent electrochemical energy storage device. For this purpose, the heat-conducting device has a heat source contact region. The heat source contact region is provided for making thermally conductive contact with an adjacent electrochemical energy storage device. Furthermore, the heat-conducting device has a heat emission region, which adjoins the heat source contact region. The heat emission region is provided for emitting thermal energy to a process fluid.

The present invention relates to a heat removal device and a battery comprising said heat removal device. The invention is described in conjunction with lithium-ion batteries for powering automobile drives. It is pointed out that the invention can also be used regardless of the battery's design, its galvanic cells or the type of powered drive.

Batteries with a plurality of electrochemical energy storage devices for powering automobile drives are known from the prior art. Premature aging is common to some designs, entailing costly battery replacement.

The invention is thus based on the task of extending the battery service life.

The task is solved in accordance with the invention by the teaching of the independent claims. Preferred further developments of the invention are set forth in the subclaims.

The inventive heat removal device comprises a first measuring device which is provided for the purpose of detecting a first physical parameter. The inventive heat removal device comprises a heat-conducting device which is provided for the purpose of absorbing thermal energy from an adjacent electrochemical energy storage device. To that end, the heat-conducting device has one, preferably two, three, four or more heat source contact regions. A heat source contact region is provided for the purpose of making thermally conductive contact with an adjacent electrochemical energy storage device. The heat-conducting device further comprises a heat emission region adjoining the heat source contact region. The heat emission region is provided for the purpose of emitting thermal energy to a process fluid. The heat removal device is characterized in that the first measuring device is provided for the purpose of detecting a temperature in the heat source contact region, preferably at a predefined location within the heat source contact region. In accordance with the invention, the electrochemical energy storage device is pre-stressed against the heat source contact region, advantageously improving the thermally conductive contact between the electro-chemical energy storage device and the heat removal device. The detecting of the physical parameter by the first measuring device is also advantageously improved.

A heat removal device in the sense of the invention refers to a device serving in particular to remove thermal energy from at least one or more, preferably two or three adjacent electrochemical energy storage devices. Preferably, the same heat removal device removes thermal energy from a number of electrochemical energy storage devices at the same time. The heat removal device preferably feeds thermal energy intermittently to at least one adjacent electrochemical energy storage device.

A first measuring device in the sense of the invention refers to a device which particularly serves in detecting at least one physical parameter. The first measuring device preferably comprises at least one sensor, preferably a plurality of sensors, particularly preferably serving to detect various physical parameters. The first measuring device preferably detects a plurality of physical parameters simultaneously or successively. A sensor for detecting a chemical substance also falls within the concept of a first measuring device in the sense of the invention. Said first measuring device preferably indicates a chemical substance within the adjacent electrochemical energy storage devices. The first measuring device is preferably arranged at a periphery of the heat removal device, particularly a periphery of its heat-conducting device and/or its heat source contact region. The heat removal device is preferably associated with a plurality of first measuring devices. The first measuring device preferably also automatically scans its sensors simultaneously or successively. The first measuring device preferably detects the measured physical parameter values together with a value which is indicative of the time of the scan. The first measuring device preferably condenses the queried physical parameters, particularly preferably by generating a temporal mean value. Said first measuring device preferably also acts as a low-pass filter on the detected physical parameters.

A physical parameter is the sense of the invention refers in particular to temperature, pressure, electrical voltage, impedance, electrical current and electrical resistance.

A heat-conducting device in the sense of the invention refers to a body which serves in particular to absorb thermal energy from an adjacent electrochemical energy storage device. The heat-conducting device preferably comprises aluminum and/or copper. The heat-conducting device is preferably of substantially plate-shaped form having a plurality of periphery faces. A part of the heat-conducting device, particularly at least one periphery, is preferably coated with an electrically insulating substance. A part of the heat-conducting device is preferably interposed between two electrochemical energy storage devices. The shape of the heat-conducting device is preferably adapted to an adjacent electrochemical energy storage device.

A heat source contact region in the sense of the invention refers to an area of the heat-conducting device which makes thermally conductive contact particularly with the adjacent electrochemical energy storage device. A heat source contact region particularly serves as a transfer surface for a thermal flow from an adjacent electrochemical energy storage device and/or into an adjacent electrochemical energy storage device. The heat source contact region is preferably arranged on a periphery of the heat-conducting device. The heat-conducting device preferably comprises a plurality of heat source contact regions. Particularly preferred is for at least two periphery faces of the heat-conducting device to each exhibit a heat source contact region. Each heat source contact region preferably exhibits the at least one, preferably two, three, four or more, respective first measuring devices.

A heat emission region in the sense of the invention refers to an area of the heat-conducting device which serves in particular in emitting thermal energy. The heat emission region preferably emits thermal energy to a process fluid. The heat emission region is preferably arranged adjacent to a heat source contact region of the same heat-conducting device. A heat emission region is preferably disposed on a periphery of the heat-conducting device. Preferably, two heat emission regions are disposed on two different periphery faces of the heat-conducting device. A heat emission region preferably comprises integral bodies to enlarge its surface area, particularly ribs, lamellae and/or substantially rod-shaped bodies. The process fluid preferably flows to the heat emission region.

To be understood by an electrochemical energy storage device in the sense of the invention is a device which serves in particular to absorb electrical energy, to store electrical energy in chemical form and/or to emit electrical energy. To this end, the electrochemical energy storage device comprises at least one electrode stack, one electrolyte and one enclosure. The electrical energy fed to the electrochemical energy storage device is first converted into chemical energy and also stored as such in the electrode stack. Prior to electrical energy being emitted, the chemical energy is first converted into electrical energy. Converting electrical energy into chemical energy or vice versa involves a degree of energy loss and is accompanied by irreversible chemical reactions. Said irreversible chemical reactions have an aging effect on the electrochemical energy storage device, a consequence of which is reducing the utilizable charging capacity of said electrochemical energy storage device.
The irreversible chemical reactions increase in particular with rising temperatures. The electrochemical energy storage device is preferably equipped with a substantially cuboid electrode stack or a substantially cylindrical electrode coil. The electrochemical energy storage device enclosure is preferably configured with at least one metallic molded part and/or one composite film. A thermally conductive connection preferably exists between a heat source contact region of the heat-conducting device and the electrochemical energy storage device enclosure. A heat source contact region and an electrochemical energy storage device preferably conform geometrically to one another. A heat-conducting medium is preferably disposed between the electrochemical energy storage device enclosure and an adjacent heat source contact region, particularly a heat-conducting medium to enlarge the cross-sectional area of the heat source contact region subjected to the thermal flow and/or the electrochemical energy storage device enclosure.

A process fluid in the sense of the invention refers to a fluid and/or gaseous medium which is in particular provided for the transfer of heat. The process fluid preferably serves to remove thermal energy from a heat emission region of the heat-conducting device and preferably flows through and/or along a heat emission region. The process fluid preferably undergoes a phase transition at a predefined temperature. Particularly preferred is for said predefined phase transition temperature to be a few Kelvin lower than the maximum allowable operating temperature for the electrochemical energy storage device, particularly 1-5 Kelvin. The quotient of predefined temperature and maximum allowable operating temperature preferably amounts to less than 0.9.

The temperature measured in the heat source contact region approaches the wall temperature of the adjacent electrochemical energy storage device. Knowing this measured temperature sheds light on the thermal flow through said heat source contact region. The local temperature profile over time can further be determined from the measured temperature and a mathematical model of the electrochemical energy storage device. If the measured temperature approaches a predefined temperature, corrective measures can be introduced. Limiting the maximum operating temperature of the electrochemical energy storage device can also counteract premature aging due to irreversible chemical reactions. Doing so increases the expected operating life of an electrochemical energy storage device, the overall battery respectively, and solves the underlying task.

Preferred further developments of the invention will be described in the following.

It is advantageous for the first measuring device to detect a two-dimensional temperature profile. Preferably, each heat removal device of each heat source contact region comprises a first measuring device and/or temperature sensor. A temperature sensor is preferably disposed on a periphery of the heat-conducting device, a heat source contact region respectively. The first measuring device preferably comprises a plurality of temperature sensors particularly arranged in the form of a matrix. The first measuring device preferably reads said temperature sensor at predefined times and/or repeatedly. Neighboring temperature sensors are preferably spaced closer together in high-temperature areas of the electrochemical energy storage device. The temperature sensors are preferably arranged closer together along higher temperature gradients. The first measuring device is preferably configured with a two-dimensional temperature sensor which covers an area of the enclosure having a surface area larger than 0.5 cm². Particularly preferred is for the surface area of the two-dimensional temperature sensor to be as large as the contacting area of the enclosure. These embodiments serve in particular in detecting local temperature maxima and provide a basis for targeted control aimed at decelerating the aging of an adjacent electrochemical energy storage device.

The heat removal device, particularly the first measuring device, advantageously comprises at least one sensor provided in particular for detecting a pressure and/or the presence of a substance. Said sensor is signal-connected to the first measuring device which scans the sensor at predefined times. The sensor is preferably designed as a pressure sensor; seating it into a heat source contact region is particularly preferred. This pressure sensor advantageously serves to detect the internal pressure of the adjacent electrochemical energy storage device. The sensor preferably determines the presence of a substance based on its electrical conductivity and/or electric constant. The sensor for detecting a substance is preferably arranged at the lower end of the heat-conducting device or a heat source contact region and is preferably seated in a heat source contact region. The sensor for detecting a substance is preferably arranged on a periphery of the heat-conducting device in the area of a predetermined breaking point for the adjacent electrochemical energy storage device. The above-cited sensors are preferably bonded to a periphery of the heat-conducting device. The electrical input leads of the above-cited sensors preferably lead to the first measuring device.

The heat removal device advantageously comprises a data storage unit which is particularly configured to store the measured values of the first measuring device. The first measuring device preferably stores repeated measured values along with a value representing the time of the measurement in said data storage unit. The data storage unit advantageously comprises gradually discontinuous characteristics of the detected physical parameters over time. The data storage unit advantageously provides its stored data to a control unit upon request. The data storage unit preferably stores information on converting a voltage and/or current delivered by a sensor into physical parameters.

The heat removal device advantageously comprises a first fluid channel, same particularly being provided to accommodate a process fluid. The fluid channel is preferably arranged within the heat emission region. A process fluid preferably flow through said first fluid channel. The process fluid preferably flows through the first fluid channel as a function of a recorded physical parameter, particularly a temperature of the electrochemical energy storage device. A first fluid channel advantageously serves in removing thermal energy from a heat emission region by means of managed process fluid and preferably serves in feeding thermal energy to a heat emission region.

The heat removal device advantageously comprises an electrical switching device. Same is in particular provided to cut an electrical current to or from the electrochemical energy storage device. The electrical switching device is preferably arranged between an electro-chemical energy storage device and a connected consumer. The electrical switching device is provided to cut an electrical current to or from the electrochemical energy storage device as a function of recorded physical parameters. The electrical switching device is preferably connected to a control unit. Preferably, electrical energy can only be exchanged with the adjacent electrochemical energy storage device via the electrical switching device. Preferably, the electrical switching device receives a predefined signal from the control unit and cuts an electrical current between the adjacent electrochemical energy storage device and a consumer. The opening of the electrical switching device can advantageously counteract the further warming of the adjacent electrochemical energy storage device particularly due to electrical heat output. Said electrical switching device is preferably designed as a transistor, thyristor or relay. An electrical switching device preferably cuts a parallel or series connection between two electrochemical energy storage devices after receiving a predefined signal from a control unit and preferably bridges electrochemical energy storage devices after receiving a predefined signal from a control unit.

The heat removal device advantageously comprises a signal transmission device, same particularly serving to transmit signals to an external controller upon demand. The signal transmission device advantageously transmits signals from the first measuring device, a control unit and/or the data storage unit to an external receiver. The signal transmission device preferably transmits a signal to an electrical switching device and/or a data storage unit of the heat removal device. The signal transmission device is preferably designed as a transponder. The signal transmission device preferably also transmits an identifier.

The heat removal device advantageously comprises a control unit. Said control unit in particular controls the given first measuring devices, electrical switching devices, data storage unit and/or signal transmission device. The control unit is preferably configured to compare a detected physical parameter to a target value. The control unit preferably controls the signal transmission device and/or an electrical switching device as a function of the result of said comparison. Particularly preferred is for the control unit to control the electrical switching device and the signal transmission device upon a detected temperature and/or detected pressure exceeding its associated target value. The control unit preferably controls an electrical switching device and the signal transmission device upon a sensor indicating the presence of a predetermined substance, in particular the presence of electrolyte from the interior of the electrochemical energy storage device.

The heat removal device advantageously comprises one or two contact devices, same particularly being connected to an electrical consumer, preferably by means of an electric rail, electric cable or electric lead. The contact device is further connected at least indirectly to an electrochemical energy storage device. An electrical switching device is preferably arranged between the contact device and the associated electrochemical energy storage device. The contact device is preferably designed as a pole terminal or a screw connection for an electric rail, electric cable or electric lead.

A battery advantageously comprises at least one heat removal device in accordance with the invention and two electrochemical energy storage devices. The battery preferably comprises four or more electrochemical energy storage devices connected in series. Preferably, each two electrochemical energy storage devices are separated by a heat removal device pursuant the invention. The electrochemical energy storage devices and heat removal devices arranged therebetween are preferably pre-stressed against each other. The electrochemical energy storage devices are preferably configured as substantially plate-shaped flat cells. The heat removal devices therebetween are likewise of plate-shape design and partly extend beyond the edges of the electrochemical energy storage devices. The heat emission regions of the heat removal devices preferably extend beyond the adjacent electrochemical energy storage devices. The heat emission regions preferably comprise first fluid channels which are interconnected into a common channel for a process fluid. The electrochemical energy storage devices are preferably connected to electrical switching devices of the heat removal devices. Two of said heat removal devices preferably each exhibit one contact device.

Advantageously, at least one of the signal transmission devices intermittently exchanges a predefined signal with a battery control unit. The predefined signal in particular sheds light on the operating status of an electrochemical energy storage device. The battery control unit preferably receives a signal from a control unit via a signal transmission device when an electrochemical energy storage device of the battery approaches or has already assumed an undesirable operating status. The battery control unit preferably receives predefined signals, particularly periodically, from the signal transmission devices which indicate the smooth functioning of said signal transmission devices. For this purpose, the signal transmission devices are actuated by the associated control units according to said predetermined schedule. The battery control units preferably receive a signal from the individual control units subsequent the charging of the connected electrochemical energy storage devices which provides information on the electrical charge provided. The battery control unit can request predetermined data from the data storage unit, particularly two-dimensional temperature profiles along with a value is indicative of the time the data was acquired. The battery control unit preferably receives a predefined signal indicating the presence of a chemical substance. The battery control unit preferably conveys a signal to a higher-level controller which provides information on the presence of an undesired operating status, particularly an unwanted high temperature of an electrochemical energy storage device.

A battery comprising a heat removal device according to the invention is advantageously operated so as to first determine a physical parameter of an electrochemical energy storage device adjacent to the heat removal device. To this end, a sensor of the first measuring device is queried. The first measuring device converts the sensor signal into a measured value for the measured physical parameter, particularly by means of a conversion factor stored in a data storage unit. Scanning preferably occurs at predefined initial points in time, particularly several times per second. The first measuring device condenses the scanned values into a temporal mean. At predefined second points in time, the first measuring device conveys the temporal mean for a physical parameter measured during a predefined interval to the data storage unit, particularly together with a value which is indicative of the mean of the predefined interval over time. The first measuring device preferably reads a plurality of sensors successively, temporally averages the signals, converts the temporally averaged signals into values on the physical parameters and conveys these values to the data storage unit, particularly along with a value which is indicative of the temporal mean for the predefined interval. The advantageous result of this procedure is a chronological sequence of discrete detected physical parameters in the data storage unit.

The control unit advantageously compares detected physical parameters, in particular their temporal averages, to their associated target values. Said target values are preferably stored in the data storage unit. Contingent upon the comparison, the control unit triggers the transmission of a predefined signal to a higher-level controller, particularly to a battery control unit. The predefined signal advantageously sheds light on any unwanted deviation of a physical parameter's temporal mean from an associated target value. The control unit preferably triggers the transmission of a predefined signal to the higher-level controller which provides information on undesired operating states of an electrochemical energy storage device or control software updates. The control unit preferably actuates an electrical switching device in consequence of a signal from the higher-level controller and/or in consequence of the identified deviation in the temporal mean of a physical parameter from an associated target value. The actuating of the electrical switching device preferably interrupts the electrical connection between the electrochemical energy storage device and the consumer and/or switches on a cooling device, particularly for the higher-level battery.

The following description in conjunction with the figures yields further advantages, features and applications of the present invention. Shown are:

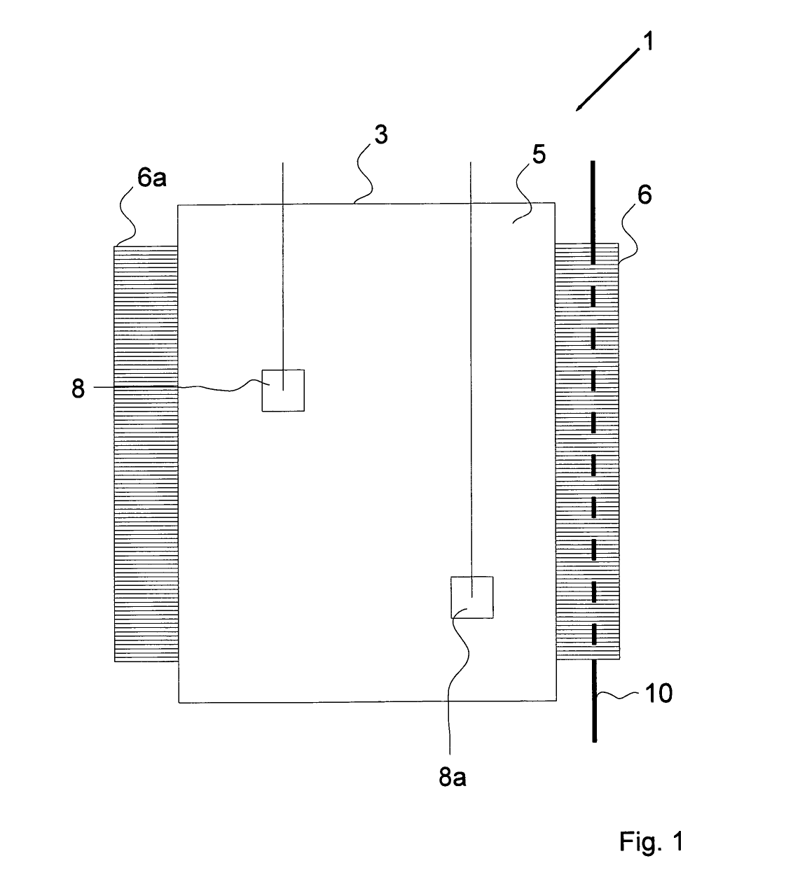

FIG. 1: a heat removal device according to the invention comprising a first fluid channel and two temperature sensors,

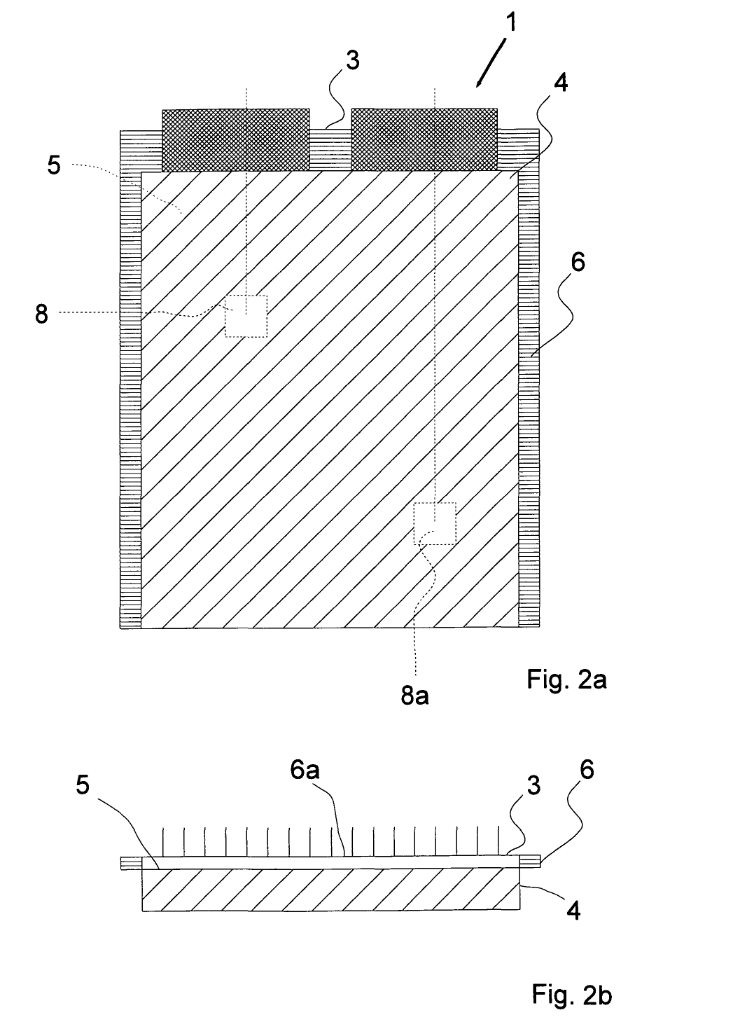

FIG. 2: a heat removal device according to the invention, its heat source contact region in thermally conductive contact with an electrochemical energy storage device,

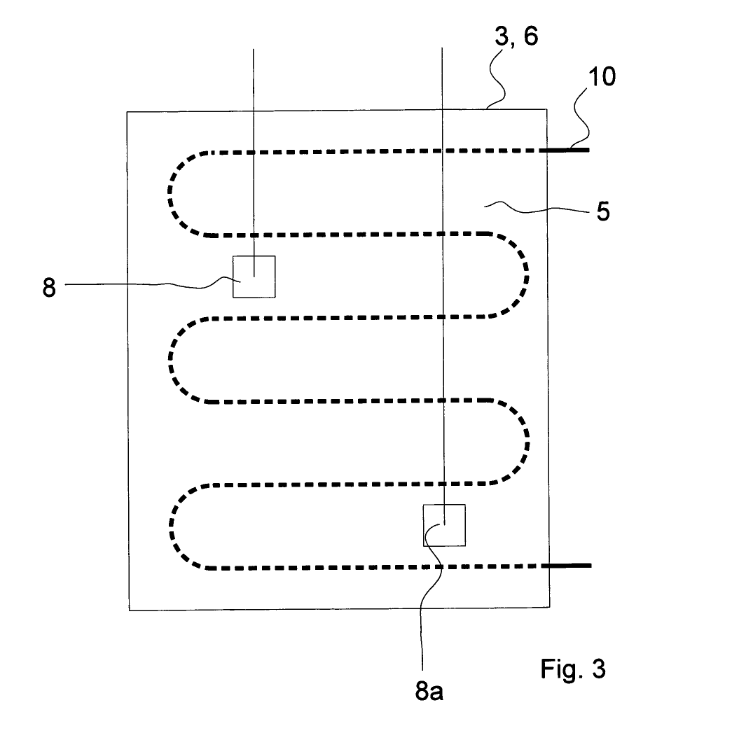

FIG. 3: a further embodiment of a heat removal device comprising a first fluid channel with overlapping heat source contact region and heat removal region,

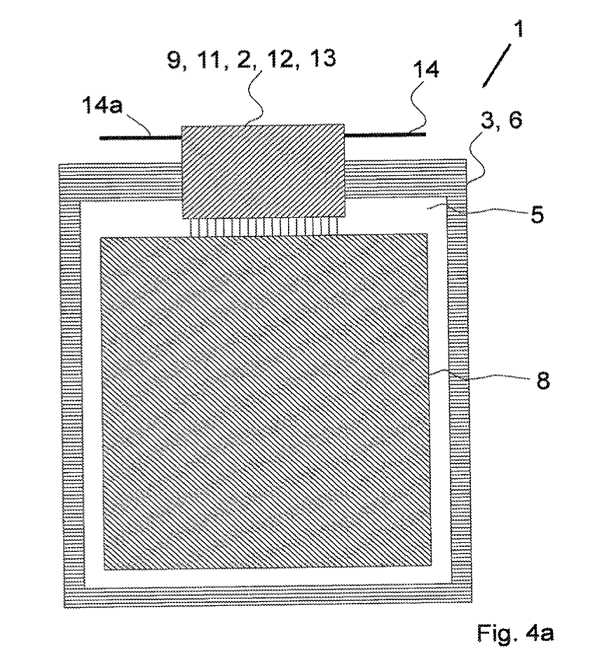

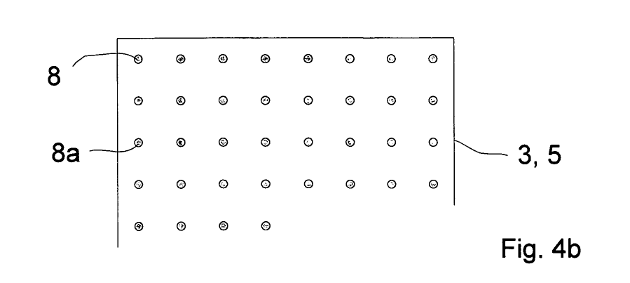

FIG. 4: a further embodiment of a heat removal device comprising a flat sensor, a data storage unit, a control unit, a signal transmission device and two electrical contact devices,

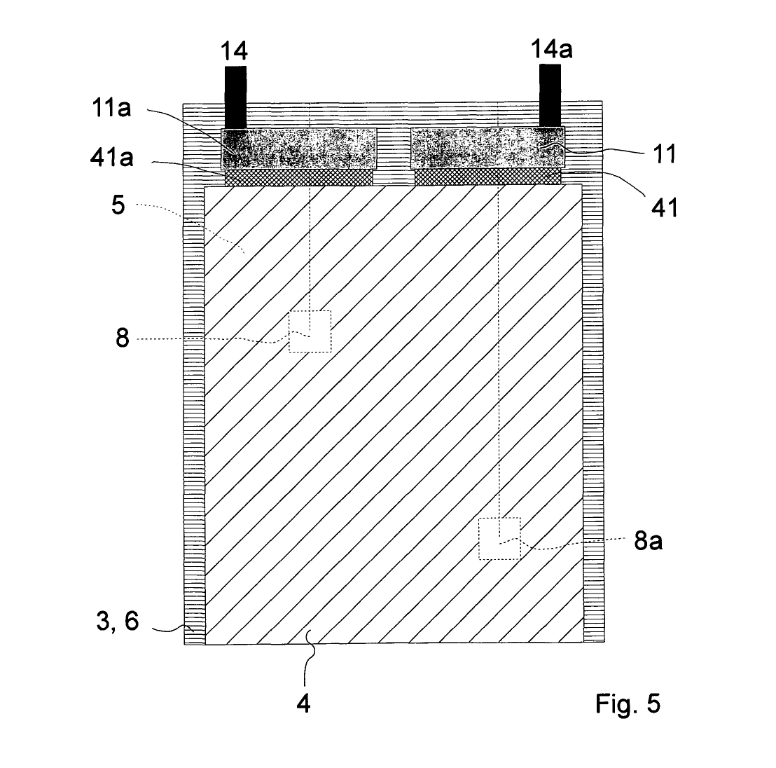

FIG. 5: a further embodiment of a heat removal device comprising an electrochemical energy storage device, its current collector connected to contact devices, and

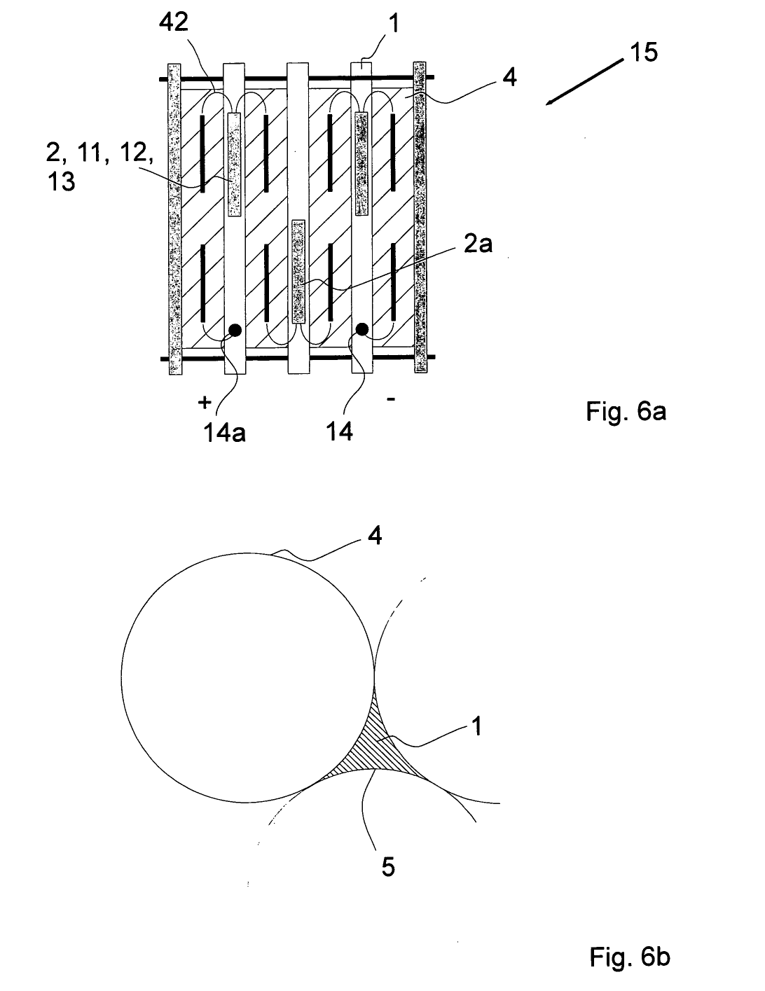

FIG. 6: a battery comprising a plurality of inventive heat removal devices pre-stressed by a plurality of prismatic electrochemical energy storage devices, an arrangement of a plurality of cylindrical energy storage devices around an inventive heat removal device, the cross section of which is essentially triangular.

FIG. 1 shows a heat removal device 1 according to the invention comprising a first fluid channel 10 and two temperature sensors 8, 8a. The heat removal device 1 comprises a heat-conducting device 3 having a heat source contact region 5 as well as two heat emission regions 6, 6a. The first fluid channel 10 leads through a heat emission region 6. The temperature sensors 8, 8a are seated in the heat-conducting device 3 within the is heat source contact region 5 and sit flush with the surface of said heat-conducting device 3. The heat source contact region 5 is provided for making thermally conductive contact with a not shown electro-chemical energy storage device. The heat emission regions 6, 6a are integrally formed with the heat-conducting device 3. The heat emission regions 6, 6a are advantageously designed with a wall thickness which tapers toward the respective outer edge. The heat-conducting device 3 is made of aluminum.

FIG. 2a shows a heat removal device 1 according to the invention, its heat source contact region 5 (with dotted reference line) covered by an electrochemical energy storage device 4. The electrochemical energy storage device 4 likewise covers the temperature sensors 8, 8a (with dotted reference lines). Part of the heat emission region 6 extends beyond the electrochemical energy storage device 4. As per FIG. 2b, the heat-conducting device 3 also comprises a heat emission region 6a on its rear side where a number of surface-enlarging ribs are integrally molded to said heat-conducting device 3.

FIG. 3 shows a further embodiment of a heat removal device 1 comprising a first fluid channel 10. The heat source contact region 5 and a heat removal region 6 are overlapping. Two temperature sensors 8, 8a are arranged flush with a periphery of the heat-conducting device 3 within the heat source contact region 5. The first fluid channel 10 extends within the heat-conducting device 3 and is arranged around the recesses for the temperature sensors 8, 8a.

FIG. 4a shows a further embodiment of a heat removal device 1 having a flat sensor 8, a data storage unit 9, a control unit 13, an electrical switching device 11, a first measuring device 2, a signal transmission device 12 and two contact devices 14, 14a. The temperature sensor 8 is formed two-dimensionally or as a matrix of individual temperature sensors 8, 8a (see FIG. 4b). The temperature sensor(s) 8, 8a are connected to the first measuring device 2 by means of a plurality of connector leads. The electronic switches (2, 9, 11, 12, 13) are arranged at the upper area of the heat removal device 1 as an electronic module. Two contact devices 14, 14a extend from said electronic module. Not shown are the connections of the electronic module to connect to the current collectors of the likewise not shown electrochemical energy storage device. The electronic module is seated in the heat-conducting device and is partially covered by the not shown electrochemical energy storage device. The signal transmission device 12 is advantageously designed as a transponder. The transponder is supplied with energy by means of an electrical field of the not shown higher-level battery control unit. In this state, the transponder transmits information selected by the control unit 13 together with its identifier to the higher-level battery control unit.

FIG. 5 shows a further embodiment of a heat removal device 1 comprising an electrochemical energy storage device 4. The current collectors 41, 41a of the electrochemical energy storage device 4 are connected to electrical contact devices 14, 14a via electrical switching devices 11, 11a. The electronic module (comprising 2, 9, 11, 12, 13) according to FIG. 3, which also contains the control unit and the first measuring device, is not shown. Temperature sensors 8, 8a are connected to the not shown first measuring device. The not shown control unit is designed to receive signals from the not shown first measuring device and control the electrical switching devices 11, 11a. When an undesired deviation is determined after measuring a temperature and comparing it to a target value, particularly the exceeding of a maximum allowable operating temperature, the not shown control unit then disconnects at least one of the electrical contact devices 14, 14a. An electrically insulating, thermally conductive layer covers the heat emission region 6 in the current collector 41 41aarea of the electrochemical energy storage device 4. The current collectors 41, 41a of the electrochemical energy storage device 4 make contact with the heat-conducting device 3 in this area. Doing so thus advantageously improves the exchange of thermal energy with the electrochemical energy storage device 4.

FIG. 6a shows a battery 15 having a plurality of inventive heat removal devices 1 pre-stressed by a plurality of prismatic electrochemical energy storage devices 4. The electrochemical energy storage devices 4 are interconnected in series. The battery 15, also having four electrochemical energy storage devices 4, comprises two electrical contact devices 14, 14a in association with two heat removal devices 1. The battery 15 has a not shown battery control unit which exchanges signals with the various control units 13 via signal transmission devices 12. Connecting wires 42 connect the current collectors 41, 41a to the electrical switching devices 11.

FIG. 6b shows an arrangement of a plurality of cylindrical energy storage devices 4 and a heat removal device 1 in accordance with the invention. The cross section of the heat removal device 1 is adapted to the shape of the surrounding electrochemical energy storage devices 4. The heat source contact region 5 thus adapts to the respective electrochemical energy storage device 4. Not shown are the first measuring device, its sensor and the first fluid channel extending through the heat-conducting device 3.

1.-7. (canceled)

8. A heat removal device, comprising:
a first measuring device detecting a two-dimensional profile of a first physical parameter; and
a heat-conducting device absorbing thermal energy from an adjacent electrochemical energy storage device, the heat-conducting device including:
a heat source contact region thermally and conductively contacting the adjacent electrochemical energy storage device, the first measuring device detecting the two-dimensional profile of the first physical parameter in the heat source contact region; and
a heat emission region emitting thermal energy to a process fluid.

9. The heat dissipation device according to claim 8, wherein the first physical parameter is temperature.

10. The heat dissipation device according to claim 8, wherein:
the first measuring device includes a plurality of individual temperature sensors arranged two-dimensionally as a matrix; and
the temperature sensor detect respective temperatures.

11. The heat dissipation device according to claim 10, wherein:
at least two of the temperature sensors are arranged closer together along a higher temperature gradient.

12. The heat dissipation device according to claim 10, wherein:
the first measuring device including an additional sensor detecting at least one of a pressure and a presence of a substance, the temperature sensors transmitting signals to the first measuring device indicating measured values of the respective detected temperatures, and the additional sensor transmitting a signal to the first measuring device a measured value of the at least one of the detected pressure and the presence of the substance;
the heat dissipation device further including:
a data storage unit storing at least one of the measured values of the first measuring device along with a time the measured value was acquired;
a first fluid channel accommodating a process fluid;
an electrical switching device, which based on the at least one measured value, selectively exchanges electrical energy between the electrochemical energy storage device and an electrical consumer and, also, selectively interrupts the exchange of the electrical energy between the electrochemical energy storage device, and the electrical consumer;
a signal transmission device transmitting the at least one measured value to an external receiver; and
a control unit controlling, based on the at least one measured value, at least one of the first measuring device, the electrical switching device, the data storage unit, the signal transmission device, and an electrical contact device connect to the electrical consumer.

13. The heat dissipation device according, to claim 8, wherein the electrochemical energy storage device is stabilized against the heat source contact region.

14. A battery, comprising:
a heat dissipation device, including;
a first measuring device detecting a two-dimensional profile of a first physical parameter; and
a heat-conducting device absorbing thermal energy from an adjacent electrochemical energy storage device, the heat-conducting device including:
a heat source contact region thermally conductively contacting the adjacent electrochemical energy storage device, the first measuring device detecting the two-dimensional profile of the first physical parameter in the heat source contact region; and
a heat emission region emitting thermal energy to a process fluid; and
two electrochemical energy storage devices, a shape of the heat-conducting device being adapted to a shape of the electrochemical energy storage devices, and the heat-conducting device being partially arranged between the two electrochemical energy storage devices.

15. The battery according to claim 14, wherein the first physical parameter is temperature.

16. The battery according to the claim 14, further including:
a battery control unit to intermittently exchange a predefined signal with a control unit.

17. A method of operating a battery comprising a heat dissipation device, including a first measuring device including a plurality of sensors detecting a two-dimensional profile of a physical parameter, and a heat-conducting device absorbing thermal energy from an adjacent electrochemical energy storage device, the method comprising the steps:
a) detecting the two-dimensional profile of the physical parameter by sensing respective ones of the physical parameters by the sensors; and
b) storing the sensed physical parameters in a data storage unit.

18. The method according to claim 17, further including:
c) comparing the physical parameters sensed in the step a) to a target value
d) transmitting at least one predefined signal to a controller based on the comparison of the step c); and
e) actuating an electrical switching device by the controller based on the predefined signal transmitted to the controller.

19. The method according to claim 18, further including:
f) based on the comparison of the step c), determining a presence of a substance in the electrochemical energy storage device:,
g) if the substance is determined to be present in the electrochemical energy storage device, transmitting the at least one predefined signal in the step and
h) if the at least one predefined signal is transmitted in the step d), actuating the electrical switching device in the step e).

20. The method according to claim 17, wherein the step a) of detecting the two-dimensional profile of the physical parameter includes:
sensing respective temperatures by the sensors.

21. The method according to claim 17, wherein the step b) of storing the sensed physical parameters includes:
storing the physical parameters in the data storage unit together with a value indicative of a respective time the physical parameter was acquired.
